(19) United States
(12) Patent Application Publication
(10) Pub. No.: US 2014/0278181 A1
(43) Pub. Date: Sep. 18, 2014

(54) INTEGRATED DATA REGISTRATION

(71) Applicant: BAE Systems Information and Electronic Systems Integration Inc., Nashua, NH (US)

(72) Inventor: Wayne W. Altrichter, Chatham, NJ (US)

(21) Appl. No.: 14/350,585

(22) PCT Filed: Aug. 9, 2013
(86) PCT No.: PCT/US13/54248

§ 371 Date: Apr. 9, 2014

Related U.S. Application Data
(60) Provisional application No. 61/681,280, filed on Aug. 9, 2012.

(51) Int. Cl. G01C 25/00

(52) U.S. Cl. CPC G01C 25/00
USPC 702/94

(57) ABSTRACT

A system and method of integrated data registration (IDR) is presented. A method receives a first position data of a fixed or moving object from a first source that is remote from the object. A second position data of the object is then received from a second source that is different than the first source and that is determined independently from the first position data. Correction estimates are determined based, at least in part, on the second position data. The first position data is then corrected with the correction estimates.

### BACKGROUND OF THE INVENTION

1. Field of Invention

The current invention relates generally to apparatus, systems and methods for determining the position of other objects through the automatic calibration of navigation and sensor systems. More particularly, the apparatus, systems and methods relate determining an object position based on sensor and/or navigation data. Specifically, the apparatus, systems and methods provide for aligning the tracking of objects in a network using sensor and/or navigation data collected from a different source and used to calibrate local sensor values.

2. Description of Related Art

The phrase “network-centric warfare” is widely used today to refer to the fact that military operations have grown increasingly reliant on the ability to exchange, process, and act upon information created by any unit operating within a “network.” This information can be used for a variety of applications including the creation and maintenance of a common track picture, local and network-wide command and decision processing, and local and network-wide engagement planning and execution. The degree to which any of this functionality can be properly and effectively discharged is highly dependent on the accuracy of the data being exchanged and the ability to combine or integrate that data in a coherent fashion. To a large extent, this accuracy will be dictated by the degree to which the sensor and navigation data from each of the participating platforms can be aligned and brought into a common reference frame, in particular the World Geodetic System 1984 (WGS-84) earth model and the Universal Coordinated Time (UTC) standard. If the alignment is done well, then the synergies commonly claimed for data sharing can be realized; if done poorly, then the result may well be worse than if no data were exchanged at all. The alignment of sensor and navigation data from multiple sensor and/or platform reference frames to a common reference frame is known as data registration.

If data registration errors are not sufficiently reduced, then a variety of tracking and engagement-related failures may occur, including: failed engagements of hostile targets; improper tactical Identifications (IDs) on targets with the potential for engagement of friendly or neutral targets; missed track-to-track correlations/target sorting; erroneous measurement-to-track association; less accurate tracking with inconsistent track pictures in networks; operator confusion with improper decision making; and inaccurate raid counts and missed sensor cues.

Currently, the United States Navy's Cooperative Engagement Capability (CEC) employs a data registration technique which is called “Gridlock.” The CEC Gridlock is a relative alignment process that uses pair-wise mutual or common targets to achieve alignment between two CEC Units (CUs). As the number of CUs increases within the network, then the number of pair-wise exchanges of mutual targets increases. This results in an increase in network bandwidth for this process thereby limiting the size of the CEC network. This also implies an increase in each CU's processing load as the numbers of CUs increases. This results in a “Closed” network solution in which only CEC CU's can participate. The CEC Gridlock solution only models 4 or 5 error states related to a target's accuracy. It can be shown mathematically, that the minimum number of physical time, navigation, and sensor errors present in the expression of a target's position error is 10 for a local navigation and single sensor, e.g., radar, aperture.

A need therefore exists for an improved approach to the estimation and removal of time, navigation, and sensor system bias errors.

### SUMMARY

The preferred embodiment of the invention includes a method of integrated data registration (IDR). The method receives a first position data of a fixed or moving object from a first source that is remote from the object. A second position data of the object is then received from a second source that is different than the first source and that is determined independently from the first position data. Correction estimates are determined based, at least in part, on the second position data. The first position data is then corrected with the correction estimates and/or the first source (aperture) is calibrated.

An integrated data registration (IDR) logic includes an interface, a data registration and buffering logic, and a filter logic. The interface receives first position data corresponding to the location of an object and also receives a second position data that is different than the first position data and is also generated at a remote location. The second position data also corresponds to a location of the object. The data registration and buffering logic next registers and buffers the first position data and the second position data. The filter logic then filters at least some of the first position data and the second position data to produce error corrections to correct for errors in the first position data. The error corrections are based, at least in part’ on the second position data from the second aperture.

### BRIEF DESCRIPTION OF SEVERAL VIEWS OF THE DRAWINGS

One or more preferred embodiments that illustrate the best mode(s) are set forth in the drawings and in the following description. The appended claims particularly and distinctly point out and set forth the invention.

The accompanying drawings, which are incorporated in and constitute a part of the specification, illustrate various example methods, and other example embodiments of various aspects of the invention. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 illustrates a schematic representation of the preferred embodiment of a system implementing integrated data registration (IDR).

FIG. 2 illustrates the comparing of radar measurements when two friendly aircraft provide precise participant location and identification (PPLI) messages to an IDR system.

FIG. 3 illustrates the IDR concept using mutual/common target objects.

FIG. 4 illustrates an embodiment of a method for using IDR.

Similar numbers refer to similar parts throughout the drawings.

### DETAILED DESCRIPTION

The preferred embodiment of the system 1 of FIG. 1 includes Integrated Data Registration (IDR) technology. IDR algorithms provide a comprehensive data registration solution, suitable for implementation in most sensor and/or Command & Control (C2) war fighting systems. The IDR algorithms permit the alignment of local sensor and navigation data to absolute geographic (WGS-84) and time (UTC U.S. Naval Observatory (USNO)) standards given appropriate reference data, and will gracefully degrade to relative alignment if that reference data is not available.

The preferred embodiment can be used in “network-centric warfare” types of environments. The phrase “network-centric warfare” is widely used today to refer to the fact that military operations have grown increasingly reliant on the ability to exchange, process, and act upon information created by any unit operating within a “network”. The network may actually be a collection of dissimilar communication networks, but the desired result is the same: the exchange and use of intelligible information to make better decisions and to execute those decisions more efficiently and effectively. One large area of network-centric warfare, often referred to as “sensor networking”, is concerned with the exchange of sensor measurement and/or track data. Sensor networking systems are designed to exchange sensor measurement or track data amongst the participants in the network where the number of participants may be any number greater than one. This shared data can be used for a variety of applications including the creation and maintenance of a common track picture, local and network-wide command and decision processing, and local and network-wide engagement planning and execution.

The preferred embodiment provides for a well-balanced system 1. The degree to which any of this functionality can be properly and effectively discharged is highly dependent on the accuracy of the data being exchanged and the ability to combine or integrate that data in a coherent fashion. To a large extent, this accuracy will be dictated by the degree to which the sensor data from each of the participating platforms can be aligned and brought into a common reference frame. If the alignment is done well, then the synergies commonly claimed for data sharing systems can be realized; if done poorly, then the result may well be worse than if no data were exchanged at all. The alignment of sensor and navigation data from multiple sensor and/or platform reference frames to a common reference frame is known as data registration. A data registration process called the Integrated Data Registration (IDR) capability, a set of algorithms that can be implemented in C++ code (or other software languages) and suitable for integration in most sensor and/or C2 systems, may be designed and implemented using Service-Oriented Architecture (SOA) principles.

These algorithms allow the preferred embodiment in one example configuration to permit the alignment of local sensor and navigation data to absolute geographic (WGS-84) and time (UTC (USNO)) standards given appropriate reference data, and will gracefully degrade to relative alignment if that reference data is not available. However, local unit data registration represents only a small portion of the total capability represented by these algorithms. Through various reformulations and enhancements of these algorithms a variety of other sensor/navigation-critical data processing issues can be addressed including the alignment of remote unit data, and the detection and mitigation of GPS denial and spoofing.

A sensor system that can be used in the preferred embodiment is designed to detect and measure the position (and sometimes the radial rate) of objects within its field of view, relative to the sensor aperture. A navigation system is designed to measure the position, rates, and orientation of itself (and, to a first approximation, the platform to which it is mounted) relative to the earth, or more precisely, relative to a commonly accepted, high-fidelity model of the earth, e.g., WGS-84. Neither of these types of systems can perform this measurement task perfectly, and the errors realized in making these measurements can be classified as being of three distinct types. The first category of errors are random and variable (in that the individual values of a collection of them would appear to be independent of one another), but may be modeled with some degree of accuracy by known statistical distributions. These might also be referred to as “rapidly varying” errors. The second category of errors may or may not be random, but they are relatively slowly varying. The third category of error may or may not be random but are fixed in magnitude, i.e., static. The first category of error is typically referred to as noise and it is addressed using a variety of filtering or smoothing techniques; the second and third categories are commonly referred to as biases and can also be addressed using a variety of estimation techniques. These error types are always present in measurements and, for the types of sensors and navigation systems found in tactical platforms today, the estimation and correction of both must be addressed if a tactical data link or sensor networking system is to function properly.

The problem, however, is more complicated. Since a sensor aperture is rarely located and aligned precisely with the navigation system with which it is associated, there exist additional biases in the location and orientation of the sensor aperture relative to the navigation system. Practically speaking, these biases exist no matter how much care is taken to survey the location and orientation of the sensor aperture. That being the case, if precise alignment of sensor data is required for a given application, then these biases should be examined to determine whether they are of such a magnitude that they must be estimated and removed before the system can arrive at a correct solution for data alignment.

If data registration is not performed properly, then a number of problems will arise in the sensor network or data link system and the quality of the end product using these improperly registered measurements may vary from poor to unusable or worse. If the measurements are very poorly aligned, then it may be impossible to associate measurements of the same object with a single track, resulting in multiple copies of a track for a single object (i.e., redundant tracks). If the measurements are well enough aligned to associate with the same track, but still not well-aligned (the residual biases are comparable to the standard deviation value of the measurement noise), then the accuracy of the resulting track may not be adequate for the purposes for which it is intended (e.g., decision-making and engagement support). Other errors that can arise from poorly aligned data include improper tactical IDs on targets, inaccurate raid counts, missed sensor cues, and poor engagement execution.

While the emphasis in the discussion so far has been on the effects of sensor biases on sensor network and data link systems, it is important to note that these problems may exist on a single unit attempting to integrate or combine data from multiple local sensors. However, the introduction of remote sensor data, whether in the form of measurements or tracks, will exacerbate the problems so that use of the remote data is impossible unless steps are taken to mitigate the various bias errors.

The preferred embodiment provides a unique integrated approach to the estimation and removal of time, navigation, and sensor system bias errors. The IDR algorithms are an absolute data registration solution that is suitable for a wide variety of joint sensor, combat, and weapons systems. The IDR algorithms are suitable for a variety of sensor types, e.g., radar, laser, infrared, 3-dimensional, 2-dimensional, or 1-dimensional. The solution solves for the primary physical errors present in sensor measurement or track position reports received from multiple local sensor apertures or between local and remote units. The IDR can utilize a proven 11-state geodetic Sensor Registration Kalman Filter (SRKF) augmented with a 3-state local Navigation Registration Kalman Filter (NRKF). The result provides for an Integrated Data Registration solution that incorporates Time Registration, Navigation Registration, and Sensor Registration error estimation in a Data Registration Kalman Filter (DRKF). The IDR DRKF and NRKF combined estimation processes provide a unique and innovative data registration capability that can calibrate and remove these registration bias errors.

Those skilled in the art will appreciate that the preferred embodiment is a unique solution to the data registration problem which incorporates the use of available local (on-board) and remote (off-board) navigation and sensor information.

One unique aspect of the IDR solution of the preferred embodiment is the innovative design for the adaptive and interactive sharing of the navigation registration solution in the NRKF and the sensor/time registration solution in the DRKF. In general, a given target's position accuracy depends on the combined time, navigation, and sensor errors present in the local combat systems. The removal of these combined systemic bias errors is the fundamental problem for which the preferred embodiment has been designed. The basic principal is that each local unit is responsible for estimating the time, navigation, and sensor registration errors for each of its local sensor apertures. This precludes the need to estimate the registration errors of other units (assuming those units are also using IDR) and permits the exchange of corrected (i.e., aligned) data amongst network units. A benefit of this approach is that the filter implementation for the IDR solution scales with the number of error states of a given sensor on the local unit and is completely independent of the number of units in the network, unlike the case for a shared pair-wise alignment solution. The result is an “open” network solution in which the locally aligned sensor and navigation data may be interpreted unambiguously by any other participant in any network, i.e., data represented in the WGS-84 and UTC (USNO) references may be used directly by any participant without the need for transformation to interpret the data.

FIG. 1 illustrates an example IDR system 1 as a high-level architecture of the IDR algorithms. This architecture allows the design to be suitable for a wide variety of tactical systems. The preferred embodiment of the system 1 is a collection of algorithms that perform the fundamental time, navigation, and sensor registration processing required to geodetically and relatively align data for a variety of navigation and sensor systems using available navigation and sensor reference data sources. The preferred embodiment of the system 1 includes an input interface 3, data registration and buffering logic 5 and filter logic 7. As discussed further below, the input interface can receive navigation and sensor data from a variety of sources. For example, it can receive navigation data from a navigation interface 11, receive sensor data (for example radar data) from a sensor interface 13, receive remote data from remote units from a communication (corns) interface 15 and receive Link 16 Precise Participant Location and Identification (PPLI) messages over a TDL interface 17.

“Logic”, as used herein, includes but is not limited to hardware, firmware, software and/or combinations of each to perform a function(s) or an action(s), and/or to cause a function or action from another logic, method, and/or system. For example, based on a desired application or needs, logic may include a software controlled microprocessor, discrete logic like an application specific integrated circuit (ASIC), a programmed logic device, a memory device containing instructions, or the like. Logic may include one or more gates, combinations of gates, or other circuit components. Logic may also be fully embodied as software. Where multiple logics are described, it may be possible to incorporate the multiple logics into one physical logic. Similarly, where a single logic is described, it may be possible to distribute that single logic between multiple physical logics.

As illustrated, the data registration and buffering logic 5 may contain logic and/or software to perform data registration (DR) source selection, buffering and measurement preprocessing 19 as well as data registration preprocessing and screening logic 21. The filter logic 7 can contain a navigation filter 23 and a sensor filter 25. The navigation filter 23 can be a 3-state NRKF filer and the sensor filter 25 can be a 14-state DRKF filter. A shared navigation corrections estimates bus can be connected between these two filters so that correction data can be shared.

The IDR algorithms utilize any Self-Reported Objects (SROs) within the communication or Tactical Data Link (TDL) networks available. For example, the TDL Link 16 Precise Participant Location and Identification (PPLI) messages are SROs that are periodically transmitted and include the WGS-84 position of each Link 16 network participant. The Identification Friend or Foe (IFF) Mode S Extended Squitter, and the IFF Mode 5 Level 2 systems also provide position reports that serve as SROs. The IDR concept of using SROs to achieve a data registration solution is displayed in FIG. 2. In this figure, two friendly Link 16 network participants each send PPLI messages to a remote ship 33 and an airborne warning and control system (AWACS) airplane 35 so that radars in ship 33 and AWACS plane 35 can be more accurately calibrated.

Referring to FIG. 3, the preferred embodiment of the IDR system 1 can be implemented to utilize common (or mutual) target observations from multiple local or remote sensors to estimate data registration errors. The fully integrated treatment of data registration—geodetic sensor registration, navigation registration, and time registration—utilizing self-reporting object data as well as measurements from Common Air Objects (CAOs), results in the capability of the present invention. In the implementation of FIG. 3, an IDR system 1 can be implemented in a local AWACS airplane 41. It can have a local sensor 42 that it uses to locate a target 43 that it believes is at position A. An IDR system 1 in the AWACS airplane 41 can receive position information from a remote sensor 45 that determines the location of the common target at position B. Knowing that the remote sensor 45 has more accurate data of the location of the target 43, the AWACS 41 can (through its IDR system 1) compensate and/or calibrate values of its local sensor 42 so that it can now more accurately find objects with its local sensor 42.

The Time Registration errors modeled in the IDR algorithms are comprised of residual time bias errors that may be present in local sensor measurements. The IDR processing estimates these errors and provides the means to remove them.

The IDR algorithms employ the combination of inertial navigation system (INS), global positioning system (GPS), and Link-16 navigation data to provide direct measurements for the estimation of the navigation registration errors for the local unit using a Navigation Registration Kalman Filter (NRKF). The NRKF also incorporates navigation position error measurements derived from Common Air Objects (CAOs) (i.e., measurements from multiple sensors used to update the track of a single object) between local and remote sensors.

Sensor measurement bias errors (range, azimuth, elevation, and Doppler), and aperture alignment bias errors (the aperture orientation angles) relative to the body-frame of the local unit, are the primary sensor errors contributing to biased sensor measurement reports. Estimation and correction of these sensor bias errors is desired, since measurement accuracy ultimately determines the performance of vital tracking algorithms such as track-to-track correlation, measurement-to-track association, and critical downstream processing functionality such as combat identification (ID) and engagement planning/prosecution. In the preferred embodiment, the IDR algorithms estimate and remove these critical biases to align the sensor measurements to the WGS-84 reference frame and UTC (USNO) time standard. The IDR algorithms account for the fact that the sensor registration corrections applied to a given measurement are generally a function of the position of each measurement relative to the sensor aperture, i.e., the corrections are not simply constant offsets across the entire field-of-view (FOV) of the sensor aperture but vary with the position of the object relative to the aperture. The ability of the IDR algorithms to use SRO and CAO measurements to estimate and remove these complex errors inherent in all sensor systems offers a significant degree of accuracy and robustness in data registration performance.

Example methods may be better appreciated with reference to flow diagrams. While for purposes of simplicity of explanation, the illustrated methodologies are shown and described as a series of blocks, it is to be appreciated that the methodologies are not limited by the order of the blocks, as some blocks can occur in different orders and/or concurrently with other blocks from that shown and described. Moreover, less than all the illustrated blocks may be required to implement an example methodology. Blocks may be combined or separated into multiple components. Furthermore, additional and/or alternative methodologies can employ additional, not illustrated blocks.

FIG. 4 illustrates a method 400 of method of integrated data registration (IDR). The method 400 includes receiving a first position data of an object, at 402, from a first source that is remote from the object. A second position data of the object is then received, at 404, from a second source that is different than the first source and that is determined independently from the first position data. The first position data can be at least partly generated by a first aperture and the second position data can be generated by a second aperture. Correction estimates are determined, at 406, based, at least in part, on the second position data. These estimates can be determined as discussed earlier. The first position data is then corrected with the correction estimates, at 408. This can be performed as discussed above and results in the first aperture now being able to make more accurate measurements.

In the foregoing description, certain terms have been used for brevity, clearness, and understanding. No unnecessary limitations are to be implied therefrom beyond the requirement of the prior art because such terms are used for descriptive purposes and are intended to be broadly construed. Therefore, the invention is not limited to the specific details, the representative embodiments, and illustrative examples shown and described. Thus, this application is intended to embrace alterations, modifications, and variations that fall within the scope of the appended claims.

Moreover, the description and illustration of the invention is an example and the invention is not limited to the exact details shown or described. References to “the preferred embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in the preferred embodiment” does not necessarily refer to the same embodiment, though it may.

What is claimed is:

1. An integrated data registration (IDR) logic comprising:
an interface configured to receive first position data from a first aperture corresponding to a location of an object, wherein the interface is further configured to receive second position data that is generated by a second aperture at a different location than where the first position data was determined and is generated independently of the first position data, wherein the second position data corresponds to the location of the object;
data registration and buffering logic configured to register and to buffer the first position data and the second position data; and
filter logic configured to filter at least some of the first position data and the second position data to produce error corrections to correct for errors in the first position data, wherein the error corrections are based, at least in part, on the second position data from the second aperture.

2. The IDR logic of claim 1 further comprising:
screening logic configured to screen the first position data for data values to be filtered by the filter logic.

3. The IDR logic of claim 1 wherein the filter logic further comprises:
a navigation data filter configured to filter navigation data; and
a sensor data filter configured to filter sensor data.

4. The IDR logic of claim 3 wherein the first position data includes local navigation and sensor data and the second position data includes at least one of: remote navigation data and remote sensor data, and wherein the navigation data filter is configured to filter the local navigation and sensor data and the sensor data filter is configured to filter the at least one of: remote navigation data and remote sensor data.

5. The IDR logic of claim 4 wherein the error corrections further comprise:
local navigation corrections and local sensor corrections.

6. The IDR logic of claim 5 further comprising:
connections between the navigation filter and the sensor filter to allow the local navigation connections to be shared with the sensor data filter and to allow the local sensor corrections to be shared with the navigation data filter.

7. The IDR logic of claim 3 wherein the navigation data filter further comprises:
three states; and wherein the sensor navigation filter further comprises: 14 states.

8. The IDR logic of claim 3 wherein the navigation filter further comprises:
a navigation registration Kalman Filter (NRKF).

9. The IDR logic of claim 3 wherein the sensor data filter further comprises:
a data registration Kalman filter (DRKF).

10. The IDR logic of claim 1 wherein the error corrections comprise:
range error, bearing error and elevation error.

11. The IDR logic of claim 1 wherein the interface is configured to receive the first position data from an aperture that is a sensor, such as, but not limited to a radar, and wherein the interface is configured to receive the second position data from the object.

12. The IDR logic of claim 11 wherein the object is at least one of the group of; a fixed object and a moving object relative to the radar.

13. A method of integrated data registration (IDR) comprising:
receiving first position data of an object from a first source that is remote from the object;
receiving second position data of the object from a second source that is different than the first source and that is determined independently from the first position data;
determining correction estimates based, at least in part, on the second position data; and
correcting the first position data with the correction estimates.

14. The method of claim 13 wherein the receiving first position data further comprises:
receiving local navigation data of an object implementing the method of IDR and wherein the determining correction estimates further comprises:
determining local navigation corrections estimates; and
updating location local navigation indicators based, at least in part, on the local navigation estimates.

15. The method of claim 13 further wherein the second source is the object.

16. The method of claim 13 wherein the receiving second position data further comprises:
receiving the second position data, as a precise participant location and identification (PPLI) message from the second source that is a self-reporting object (SRO).

17. The method of claim 16 wherein the SRO message includes a World Geodetic System (WGS) position.

18. The method of claim 13 wherein the receiving second position data further comprises:
receiving second position data that includes time data, and wherein the determining correction estimates further comprises:
determining time correction estimates; and
correcting the a time of the first position data with the time correction estimates.

19. The method of claim 13 wherein the receiving first position data and the receiving second position data further comprising:
receiving at least one of the group of: an inertial navigation system (INS) data, a global positioning system (GPS) data, Link 16 navigation data and wherein the determining correction estimates further comprises:
determining navigation correction estimates based on at least one of the group of: the INS data, the GPS data, and the Link 16 navigation data; and
correcting navigation value with the navigation correction estimates.

20. The method of claim 13 wherein the receiving first position data of an object from a first source further comprises:
receiving the first position data from a sensor that provides at least one of the group of: a range value, an elevation value, an azimuth value and a Doppler value of the object.
